(19) United States
(12) Patent Application Publication
(10) Pub. No.: US 2017/0038502 A1
(43) Pub. Date: Feb. 9, 2017

(54) METHODS AND APPARATUS HAVING A TWO-SURFACE MICROLENS ARRAY FOR LOW F-NUMBER PLENOPTIC CAMERAS

(71) Applicant: QUALCOMM Incorporated, San Diego, CA (US)

(72) Inventor: Todor Georgiev Georgiev, Sunnyvale, CA (US)

(21) Appl. No.: 14/820,267

(22) Filed: Aug. 6, 2015

(51) Int. Cl. G02B 3/00; H04N 5/225; G02B 7/02

(52) U.S. Cl. CPC G02B 3/0062; G02B 3/0056; G02B 7/025; H04N 5/2254

(57) ABSTRACT

Innovations relating to systems for generating plenoptic images, are disclosed. One system includes an objective lens having a focal plane, a light sensor positioned to receive light propagating through the objective lens, a first optical element array positioned between the objective lens and the sensor, the first optical element array including a first plurality of optical elements, and a second optical element array positioned between the first optical element array and the sensor, the second optical element array comprising a second plurality of optical elements. Each optical element of the first optical element array is configured to direct light from a separate portion of an image onto a separate optical element of the second optical element array and wherein each optical element of the second optical element array is configured to project the separate portion of the image of the scene onto a separate location of the sensor.

### BACKGROUND

Field

This innovation generally relates to systems, methods, and methods of manufacturing imaging systems having high modulation transfer functions (MTF) with improved optical quality and low f-number

Related Art

In traditional photography, a camera is manipulated to focus on a certain small area of an image prior to taking a picture. After capturing the picture, portions of the image are either in focus or out of focus, and any areas not in focus cannot be made in focus. Conversely, a light-field, or a plenoptic, camera uses special optics and sensors to capture a light field of a scene (or view). The plenoptic camera is capable of capturing in a single image the radiance of multiple rays of light from a scene, for example, at multiple points in space. With a plenoptic camera, since the color, direction, and intensity of multiple light rays of the scene is captured, focusing may be performed using software after the image has been captured. Focusing after an image has been captured allows a user to modify which area of the image is in focus at any time.

In many plenoptic cameras, the light enters a main (objective) lens and passes through an array of microlenses before being captured by an image sensor. Each microlens of the array of microlenses may have a relatively small size, such as 100 μm, and a relatively large depth of field. This allows the camera to capture all portions of a scene by capturing numerous small images from slightly different viewpoints using each of the microlenses of the microlens array. After the scene is captured, special software extracts and manipulates these viewpoints to reach a desired depth of field of the scene during post-processing. Handheld plenoptic cameras have now become commercially available, such as those from Lytro, Inc. (Mountain View, Calif.) or Raytrix GmbH (Germany).

Plenoptic cameras use a microlens array to capture the 4D radiance of the view or scene of interest. The acquired 4D radiance, as an integral image, can be processed for either 3D scene reconstruction or synthesizing dynamic depth of field (DoF) effect. There are numerous applications for this emerging camera technology, ranging from entertainment to depth recovery for industrial and scientific applications. Some light field cameras can capture 20 different views of a scene with a 10 megapixel sensor (Adobe®, San Jose, Calif.). However, the rendered 700×700 pixel images may have visible artifacts at occlusion boundaries. The Lytro® light field (lytro.com) camera uses an 11 megapixel sensor to acquire the radiance. However, the images generated from the camera still suffer from a low resolution of one megapixel, with some visible artifacts found around thin objects and sharp edges. Thus, the Lytro cameras (and similarly other commercial products) do not have high modulation transfer functions (MTFs). The MTF identifies how well the camera (for example, the optical elements) images high frequency of detailed elements in a target scene captured by the camera (for example small objects or objects with sharp edges). When the frequency of these objects is high, cameras are unable to produce great definition of the small objects or sharp edges if they have a low MTF. Thus, it is desired to create a plenoptic camera that will respond well to scenes having a high frequency of objects therein.

### SUMMARY

The systems, methods, devices, and computer program products discussed herein each have several aspects, no single one of which is solely responsible for its desirable attributes. Without limiting the scope of this invention as expressed by the claims which follow, some features are discussed briefly below. After considering this discussion, and particularly after reading the section entitled “Detailed Description,” it will be understood how advantageous features of this invention include, among other things, providing a plenoptic camera having a high MTF and a process to make such a camera.

One innovation includes a system for generating plenoptic images, the system including an objective lens configured to refract light received from a scene, the objective lens configured to focus light at an image plane, a sensor configured to sense light received thereon, the sensor positioned to receive light propagating through the objective lens, a first optical element array positioned between the objective lens and the sensor, the first optical element array comprising a first plurality of optical elements, and a second optical element array positioned between the first optical element array and the sensor and in contact with the sensor, the second optical element array comprising a second plurality of optical elements. Each optical element of the first optical element array is configured to direct light rays passing through the image plane of the objective lens onto a separate optical element of the second optical element array and wherein each optical element of the second optical element array is configured to direct light rays received from the first optical element array onto a separate location of the sensor. In some aspects, the first plurality of optical elements have a first focal length on a first side of the first optical element array, and wherein the first optical element array is positioned at a distance from the image plane of the objective lens equal to the first focal length and further positioned such that the first side of the first optical element array receives light from the objective lens.

In some aspects, the first plurality of optical elements have a second focal length on a second side of the first optical element array, and wherein the first optical element array is positioned such that the second side of the first optical element array faces the sensor. In some aspects, the first optical element array has a first side that faces the objective lens and a second side that faces the second optical element array, wherein the first side of the first optical element array is planar, and wherein each of the first plurality of optical elements have a curved surface and the curved surfaces of each of the first plurality of optical elements are disposed on the second side of the first optical array. In some aspects, the second optical element array has a first side that faces the first optical element array and a second side that faces the sensor, and each of the second plurality of optical elements have a curved surface and the curved surfaces of each of the second plurality of optical elements are disposed on the first side of the second optical element array. In some aspects, the second side of the second optical element array is planar. In some aspects, each optical element of the first optical element array is aligned with a corresponding optical element of the second optical element array. In some aspects, the second optical element array is integrated with the sensor as a single component, the second optical element arranged on a side of the sensor configured to receive light. In some aspects, the second optical element array comprises epoxy. In some aspects, the first optical element array is spaced a distance from the sensor equal to a diameter of an optical element of the first optical element array. In some aspects, the diameter of an optical element of the first optical element array is 20-30 microns. In some aspects, the first optical element array comprises a glass layer, and wherein the glass layer has a thickness of at least five times the thickness of one of the first plurality of optical elements. In some aspects, the second optical element array comprises a glass layer, and wherein the glass layer has a thickness of at least five times the thickness of one of the second plurality of optical elements.

Another innovation includes a method for generating plenoptic images, the method including capturing light projected onto a sensor by one or more optical elements, refracting light from a scene via an objective lens, the objective lens configured to focus light propagating through the objective lens at an image plane, focusing the refracted light via a first optical element array positioned between the objective lens and the sensor, the first optical element array comprising a first plurality of optical elements, and further focusing light received from the first optical element array by a second optical element array positioned between the first optical element array and a sensor, the second optical element array positioned in contact with the sensor, the second optical element array comprising a second plurality of optical elements, where each optical element of the first optical element array is configured to project a separate portion of the image of the scene formed at the image plane onto a separate optical element of the second optical element array, and wherein each optical element of the second optical element array is configured to project the separate portion of the image of the scene onto a separate location of the sensor. In some aspects, the first plurality of optical elements have a first focal length, and the first optical element array is positioned at a distance from the image plane of the objective lens equal to the first focal length. Ins some aspects, each optical element of the first optical element array is aligned with a corresponding optical element of the second optical element array, and wherein light propagating through one of the optical elements of the first optical element array is received by the corresponding optical element of the second optical element. In some aspects, the second optical element array is integrated with the sensor as a single component, the second optical element array arranged on a side of the sensor configured to receive light. In some aspects, second optical element array comprises epoxy. In some aspects, the first optical element array is spaced a distance from the sensor equal to a diameter of an optical element of the first optical element array. In some aspects, the diameter of an optical element of the first optical element array is 20-30 microns.

Another innovation includes a method of manufacturing one or more optic elements for a plenoptic imaging system, including depositing epoxy on a sensor configured to sense light received thereon, providing a first array of optical elements for the plenoptic imaging system, the first array of optical elements having first plurality of optical elements, forming a second array of optical elements comprising the epoxy, the second array of optical elements having a second plurality of optical elements, each of the second plurality of optical elements configured to direct light to one or more pixels of the sensor, positioning the sensor and the second array of optical elements at a location to receive light from the first array of optical elements and at a distance from the first array of optical elements that is less than the distance of a focal length of one of the first plurality of optical elements, and positioning the first array of optical elements between the sensor and an objective lens, the objective lens configured to focus light at an image plane between the first array of optical elements and the objective lens, the first array of optical elements being positioned at a distance from the image plane that is equal to the focal length of one of the first plurality of optical elements. In one aspect, the first array of optical elements has a first side that faces the objective lens and a second side that faces the second array of optical elements, the first side of the first array of optical elements is planar, and each of the first plurality of optical elements have a curved surface and the curved surfaces of each of the first plurality of optical elements are disposed on the second side of the first optical array. In one aspect, the second array of optical elements has a first side that faces the first optical array and a second side that faces the sensor, and each of the second plurality of optical elements have a curved surface and the curved surfaces of each of the second plurality of optical elements are disposed on the first side of the second array of optical elements. In one aspect, the second side of the second array of optical elements is planar. In one aspect, the method further includes aligning each the second plurality of optical elements and a corresponding one of the first plurality of optical elements so that light propagating through one of the first plurality of optical elements is received by the corresponding one of the second plurality of optical elements. In one aspect, the method includes forming the second array of optical elements array by replication from a master array of optical elements. In one aspect, the first array of optical elements is spaced a distance from the sensor equal to a diameter of an optical element of the first array of optical elements. In one aspect, the diameter of one of the first plurality of optical elements is 20-30 microns. In one aspect, the first array of optical elements are formed on a glass layer having a thickness at least five times the thickness of the one of the first plurality of optical elements. In one aspect, the second array of optical elements are formed on a layer of epoxy having a thickness at least five times the thickness of one of the second plurality of optical elements.

### BRIEF DESCRIPTION OF THE DRAWINGS

The foregoing and other features of the present disclosure will become more fully apparent from the following description and appended claims, taken in conjunction with the accompanying drawings. Understanding that these drawings depict only several embodiments in accordance with the disclosure and are not to be considered limiting of its scope, the disclosure will be described with additional specificity and detail through use of the accompanying drawings.

FIG. 1 is a schematic block diagram of an example of one embodiment of a plenoptic camera linked to an image processing system, wherein the plenoptic camera is configured to have a high modulation transfer function (MTF) and a low f-number.

FIG. 2 is a schematic block diagram of an example of one embodiment of a plenoptic camera linked to an image processing system, wherein the plenoptic camera is configured to have a high MTF and a low f-number, further showing various components of the plenoptic camera and image processing system.

FIG. 3 is an exploded view of a photosensor microlens array and microlens array including a plurality of microlenses on each array.

FIG. 4A depicts a schematic block diagram and an associated MTF chart for a first embodiment of a two-surface microlens array for a low F-number plenoptic camera.

FIG. 4B depicts a schematic block diagram and associated MTF chart for a second embodiment of a two-surface microlens array for a low F-number plenoptic camera.

FIG. 4C depicts a schematic block diagram and associated MTF chart for a third embodiment of a two-surface microlens array for a low F-number plenoptic camera.

FIG. 4D depicts a schematic block diagram and associated MTF chart for a fourth embodiment of a two-surface microlens array for a low F-number plenoptic camera.

FIG. 5 illustrates a flow chart of an example of a method for manufacturing a two-surface microlens array for a low F-number plenoptic camera.

FIG. 6 illustrates a flow chart of an example of a method of capturing an image using a two-surface microlens array of a low F-number plenoptic camera.

### DETAILED DESCRIPTION

Multiple embodiments of a method, apparatus, and method of manufacturing for full-resolution light field capture using a two-surface microlens array (or similar structure) are described herein. In some embodiments, the method, apparatus, and method of manufacturing may apply to a full-resolution plenoptic camera (also referred to as a radiance camera or light-field camera) or to components of the camera. These methods and apparatus provide improvements over existing commercial embodiments in the image capture capabilities of plenoptic cameras embodying the disclosed two-surface microlens arrays (or similar structures). In some embodiments, the plenoptic camera described herein may be part of a cellular telephone or other mobile device and thus be size constrained to fit within a compact package. In other embodiments the plenoptic camera may be a standalone imaging device (for example, a camera).

Plenoptic cameras enable many new possibilities for digital imaging because they capture both spatial and angular information, for example, the full four-dimensional radiance, of a scene. Embodiments can produce a refocusable, high-resolution final image by generating a depth map for each pixel captured by the plenoptic camera. High-resolution may allow for capturing of four-dimensional data with a two-dimensional sensor used in many commercial cameras. However, the images produced from plenoptic cameras often have low resolution.

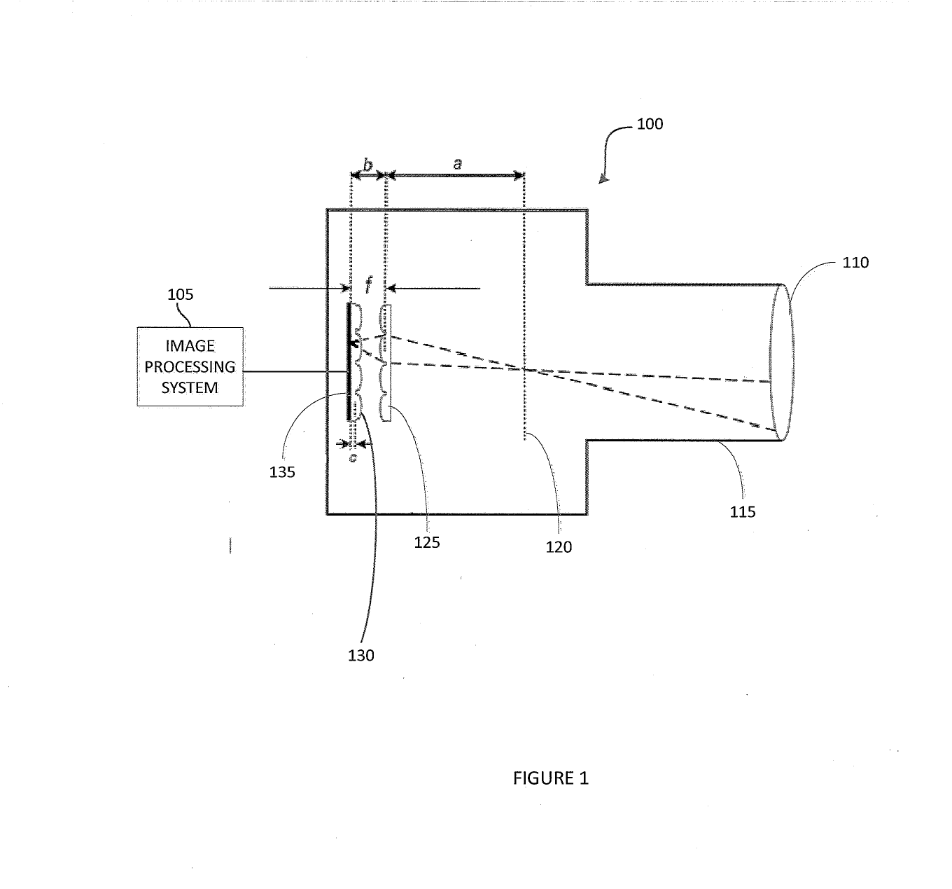

FIG. 1 is a block diagram of an example of an embodiment of a plenoptic imaging system 100 that includes a plenoptic camera 115 that is coupled to an image processing system 105. The image processing system 105 is in communication with the plenoptic camera 115 and is configured to receive and process images that are captured by the plenoptic camera 115. In some embodiments, the plenoptic camera 115 may comprise at least one optical element used within a camera system, wherein the camera system (not shown in this figure) is configured to capture an image of a scene as viewed by the plenoptic camera 115. The image processing system 105 may include the components used to manipulate, process, or save the captured image.

The plenoptic camera 115 includes components that are configured to receive, guide and sense light from a scene. As illustrated in FIG. 1, the plenoptic camera 115 includes an objective lens 110 (which may also be referred to as a mains lens), a microlens array 125 (which may also be referred to as a first microlens array), a photosensor microlens array 130 (which may also be referred to herein as a second microlens array), and a photosensor 135. The objective lens 110 is positioned and exposed to receive light from a scene which may include at least one object of interest located somewhere in the scene (for example, a scene or object in the field-of-view of the plenoptic camera 115). Light received at the objective lens 110 propagates through the objective lens 110, and further propagates through a main lens image plane 120 before being incident on a microlens array 125. In the illustrated embodiment, the microlens array 125 may include a two-dimensional array of individual microlenses, where each of the microlenses of the microlens array 125 may be of the same size and shape. The microlens array 125 may comprise sufficient microlenses and be positioned such that active areas of the photosensor 135 receive at least a portion of the image formed by light propagating through the objective lens 110. The microlens array 125 maybe formed on or from a substrate (or wafer) having a certain thickness, and after formation the thickness of the microlens array 125 may be the same or substantially the same as the thickness of the wafer formed therefrom or thereon.

The objective lens image plane 120 is a plane located where rays of light from a target scene that propagated through the objective lens pass through, such rays forming an image of the scene at the image plan 120. The target scene may be reflecting radiation (e.g., light) or emitting radiation (e.g., light), be reflecting and emitting light. In some embodiments, a first plurality of microlenses in the microlens array 125 may be focused on the main lens image plane 120 of the objective lens 110. That is, the microlens array 125 may have a focal length, in the direction of the main lens image plane 120, the focal length being equal to, or substantially equal to, the distance between the first microlens array 125 and the image plane 120 of the objective lens 110. While there may not be any structure physically located at the main lens image plane 120, the main lens image plane 120 may be considered to be a planar location in space having an image “in the air” of the scene created by light propagating through the objective lens 110. Light received from the objective lens 110 propagates through the microlens array 125 and then propagates through the photosensor microlens array 130, which is configured to focus light onto the photosensor 135. The photosensor microlens array 130 may include a two-dimensional array of individual microlenses, and each of the microlenses of the photosensor microlens array 130 may be of the same size and shape. The photosensor microlens array 130 may include a number of microlenses arranged, and positioned, so active areas of the photosensor 135 receive at least a portion of the image as captured by the objective lens 110. The microlens array 130 may include a substrate (or wafer) from or on which the microlenses of the microlens array 130 are formed. The photosensor 135 may be located at a distance less than or equal to f from the microlens array 125, where f refers to the focal length of the microlenses of the microlens array 125 in the direction of the photosensor 135, where light propagating through the microlens array 125 and also propagating through the photosensor microlens array 135 is focused. The photosensor microlens array 130 may couple to, form on, or otherwise adhere to the photosensor 135, such that there is a distance between the photosensor 135 and each microlens of the photosensor microlens array 130 equal to a thickness of the microlens array 130. The distances between the photosensor 135 and the microlens arrays 125 and 130 may vary based on the optical design of the plenoptic imaging system 100. These distances may be varied to achieve a modulation transfer function (MTF) above the Nyquist frequency.

In operation, each microlens of the microlens array 125 may receive light representing or corresponding to a portion (e.g., area or region) of an image. Light representing the portion of the image may propagate through the microlens array 125 and be redirected by the microlens array 125 to be guided onto a corresponding region of the photosensor 135. Thus, each microlens of the microlens array 125 and its corresponding region of the photosensor 135 may function similarly to a small camera that captures a small image from an image at the image plane, and where the compilation of small images captured by each of the microlenses of the microlens array 125/photosensor 135 captures the image at the main lens image plane 120. By focusing the microlenses of the microlens array 125 on the image produced by the objective lens 110 at the main lens image plane 120, the plenoptic camera 115 may be configured to capture position information of radiance from a scene (e.g., the light field). This may allow the plenoptic camera 115 to generate high resolution images from the light-field images captured that surpass the resolution of images from previous cameras and that meet the requirements and desires of modern photography.

Still referring to FIG. 1, the image processing system 105 is in electronic communication with the photosensor 135 to receive and save information of light received at each pixel of the photosensor 135, the light propagating through each microlens in the microlens array 125 and the photosensor microlens array 130. In some embodiments, the photosensor 135 may comprise a plurality of pixels (for example, a megapixel photosensor, etc.), and one or more pixels of the plurality of pixels may capture portions of the scene from each microlens of the microlens array 125 and the photosensor microlens array 130. After a target image is captured on the photosensor 135, the image processing system 105 may calculate a depth for each pixel in the array or otherwise renders high-resolution images from the data collected by the photosensor 135, in embodiments of the invention.

As shown in FIG. 1, the distance “a” indicates the distance between the main lens image plane 120 and the microlens array 125. The distance “b” represents the distance between the microlens array 125 and the photosensor 135. The distance “f” as indicates the focal length of the microlenses of the microlens array 125, each of the microlenses of the microlens array 125 being of the same dimensions. As discussed above, since the photosensor 135 is located at or less than the focal length f of the microlens array 125, the focal length of the microlens array being in the direction of the photosensor 135. The distance b is less than or equal to f A distance “c” indicates a distance between the photosensor 135 and the photosensor microlens array 130, for example, a surface of a microlens in the photosensor microlens array 130 to a surface of the photosensor 135. In some embodiments, the distances a, b, and c are adjusted (accordingly adjusting the position of the microlens array 125 and the photosensor microlens array 130). The microlens array 125 and the photosensor microlens array 130 may be carefully moved and/or adjusted with regards to their positions between the main lens image plane 120 and the photosensor 135. For example, the thickness of the photosensor microlens array 130 substrate (or wafer) could be adjusted to manipulate the distance c while the microlens array 125 could be moved closer to the photosensor 135 as needed to achieve optimal design performance.

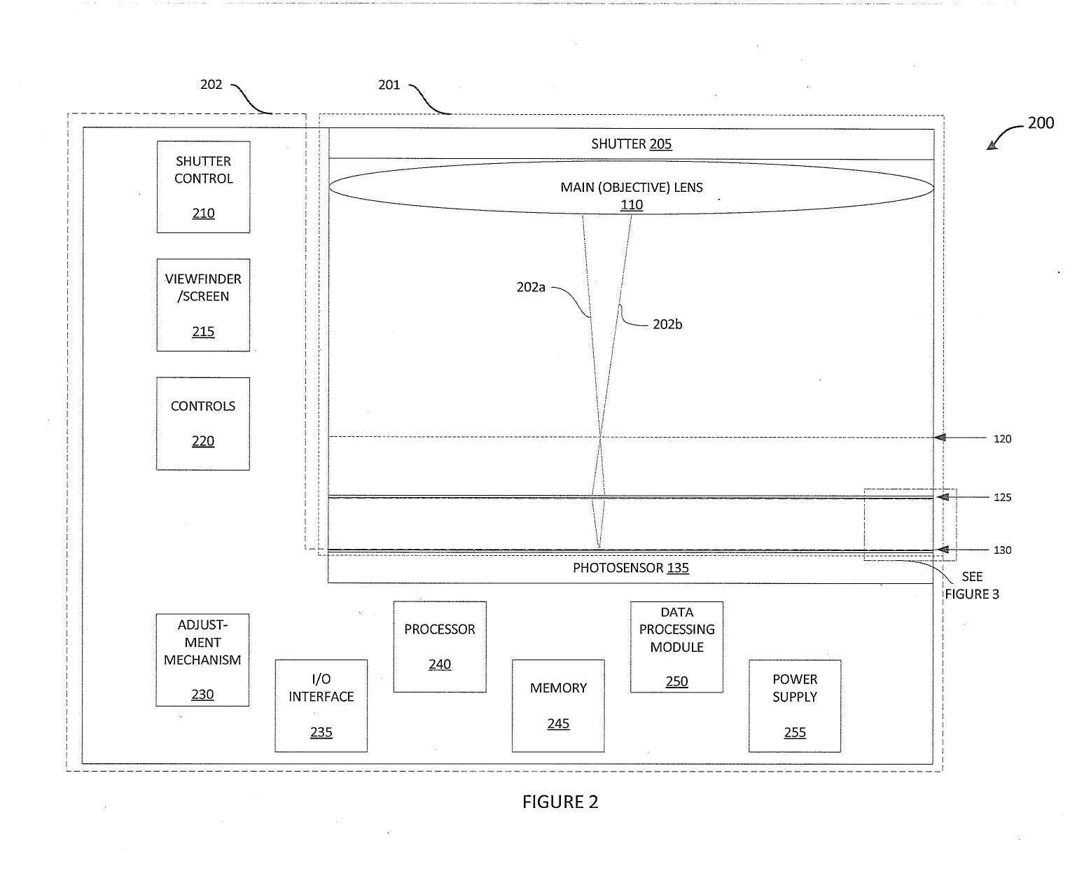

FIG. 2 illustrates an example of an embodiment of a plenoptic camera 200 including various components that may be integrated in the camera 200 (which may correspond to the plenoptic imaging system 100). The camera 200, in some embodiments, may comprise two general portions: optics 201 and controls/processing equipment 202. The optics 201 may include one or more of the optical components of the camera 200. For example, the optics 201 may include a shutter 205, the objective lens 110, the microlens array (a “first microlens array”) 125, and the photosensor microlens array (a “second microlens array”) 130. The controls/processing equipment 202 may include a variety of components, for example, the photosensor 135, a shutter control 210, a viewfinder/screen 215, a controls 220, an adjustment mechanism 230, an input/output (I/O) interface 235, a processor 240, a memory 245, a data processing module 250, and a power supply 255. In some embodiments, additional or fewer components than those listed herein may be included in the plenoptic camera 200. The components of controls/processing equipment 202 may be coupled together and/or in communication with each other as necessary to perform their associated functionality. In some embodiments, one or more components described above may be in one or more of the optics 201 and the controls/processing equipment 202. Additionally, or alternatively, one or more components of the optics 201 may be integrated into the controls/processing equipment 202, or vice versa.

In some embodiments, one or more components of the optics 201 may be in a fixed location such that they may not move in relation to the other components of the optics 201. For example, a position of one or more of the objective lens 110, the first microlens array 125, and the second microlens array 130 may be fixed in relation to one or more of the other components. In some embodiments, one or more of the components of the optics 201 may be movable in relation to one or more of the other components. For example, the objective lens 110 may be configured to be movable in a direction towards or away from the first microlens array 240, for example, for focusing. The first microlens array 125 may be configured to be movable towards or away from the objective lens 110, and/or be configured to move laterally (relative to the light optical path from the objective lens 110 to the photosensor 135), for example, to align the microlenses of the first microlens array 125 with the microlenses of the second microlens array 130. In some embodiments, the photosensor 135 of the controls/processing equipment 202 may comprise one or more of conventional film, a charge-coupled device (CCD), a complementary metal-oxide semiconductor (CMOS), or the like.

In some embodiments, the image captured on the photosensor 130 may be processed by the controls/processing equipment 200. For example, the data processing module 250 may use a full-resolution light-field rendering method (or other image processing algorithms for application to images captured by a plenoptic camera 200) to generate high-resolution images from the captured image. In some embodiments, the data processing module 250 may be implemented using hardware, software, or a combination thereof. In some embodiments, the captured image may be stored in a memory 245 for later rendering by an external rendering module configured to generate high-resolution images based on full-resolution light-field rendering (or similar) methods. In some embodiments, the external rendering module may be configured as a separate device or computer system. In some embodiments, high-resolution images generated from the captured image may be stored in the memory 245.

The shutter 205 of the plenoptic camera 200 may be located in front of or behind the objective lens 110. The shutter 205 can be configured to control when light is allowed to pass to the photosensor 135, and how much light is passed to the photosensor 135. For example, when the shutter 205 is closed, no light may pass from outside the optics 201 to the photosensor 135. When the shutter 205 is opened, light may pass through the main less 110 to and through the first and second microlens arrays 125 and 130, respectively, and to the photosensor 135. The processor 240 may be configured to receive an input from the shutter control 210 and control the opening and closing of the shutter 205 based on the shutter control 210. The viewfinder/screen 215 may be configured to show the user of the plenoptic camera 200 a preview of the image the camera 200 will capture if activated in a given direction. In some embodiments, the viewfinder/screen 215 may be configured to allow the user to view and select options (for example, via a menu or similar interface) of the plenoptic camera 200 or to view and modify images that have already been captured by the plenoptic camera 200 and stored in the memory 245. In some embodiments, the camera 200 may utilize the power supply 255 to provide power to the components of the camera 200. In some embodiments, the power supply 255 may comprise a battery (for example, a rechargeable or replaceable battery) or a connector to an external power device. The memory 245 may be configured to store images captured by the optics 201 and processed by the data processing module 250. In some embodiments, the memory 245 may be configured to store settings and adjustments as entered by the controls 220 and the adjustment mechanism 230. In some embodiments, the memory 245 may be removable or a combination of removable and permanent memory. In some embodiments, the memory 245 may all be permanent.

In some embodiments, the I/O interface 235 of the plenoptic camera 200 may be configured to allow the connection of the camera 200 to one or more external devices, such as a computer or a video monitor. For example, the I/O interface 235 may include a USB connector, an HDMI connector, or the like. In some embodiments, the I/O interface 235 may be configured to transfer information between the camera 200 and the connected external device. In some embodiments, the I/O interface 235 may be configured to transfer information wirelessly (for example via infrared or Wi-Fi). In some embodiments, the controls 220 described above may be configured to control one or more aspects of the camera 200, including settings associated with the optics 201 (for example, shutter speed, zoom, f-number, etc.), navigating the options and menus of the camera 200, or viewing and/or modifying captured images via the data processing module 250. In some embodiments, the adjustment mechanism may be configured to adjust a relative location one or more of the components of the optics 201. For example, the adjustment mechanism 230 may be configured to adjust a distance between the first microlens array 125 and the second microlens array 130 or the objective lens 110. Additionally, or alternatively, the adjustment mechanism 230 may be configured to adjust a distance between the second microlens array 130 and the photosensor 135.

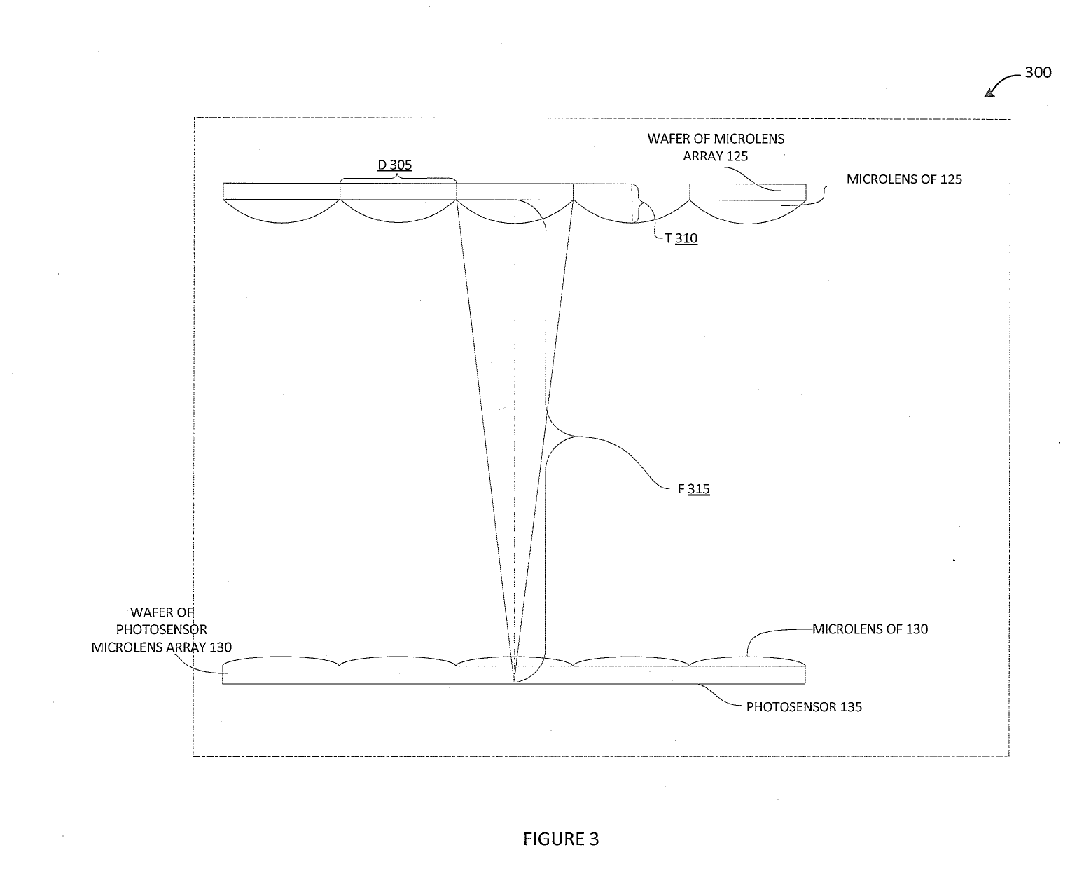

FIG. 3 is an exploded view the photosensor microlens array and microlens array comprising a plurality of microlenses on each array. The components shown in FIG. 3 are not drawn to scale. FIG. 3 depicts a blown up view 300 of a portion of each of the microlens array 125, the photosensor microlens array 130, and the photosensor 135. The microlenses of both of the microlens array 125 and the photosensor microlens array 130 have a diameter D 305, a thickness T 310, and a focal length F 315. The diameter D 305 of the microlenses of the microlens array 130 corresponds to the length of the curved lens portion along a length of the microlens array 125 wafer. In some embodiments, each of the microlenses of both the microlens array 125 and the photosensor microlens array 135 may have the same diameters 305, thicknesses 310, and focal lengths 315. As shown in FIG. 3, the diameter D 305 of the microlenses in microlens array 125 is the distance across a microlens along the longest dimension of the microlens. The thickness T 310 is the distance from the thickest portion of the curved surface of the microlens to the opposite surface of the wafer of the microlens array 125. The focal length F 315 of the microlenses is the distance from the center of the microlens (a point where the center of the curved portion of the microlens meets the wafer on which the microlens is positioned) to the point at which the image passed through the microlens is brought into focus).

Plenoptic cameras often suffer from low resolutions, be it low spatial resolutions and/or low angular resolutions. In original plenoptic cameras, a microlens array is positioned between the main lens of the camera and the photosensor of the camera. The microlens array may be positioned one focal length away from the photosensor. The main lens may be focused at the microlens array, where the microlenses of the microlens array may be focused at infinity. Since the focal length of the main lens is much greater than the focal length of the microlenses, each microlens is focused at a main camera lens aperture and not on the object being photographed. Each microlens of the microlens array may contribute to a single pixel of the final image. Thus, the number of pixels in the final image may be constrained by the number of microlenses that form the microlens array. The optical properties of these plenoptic cameras may result in both low spatial and angular resolutions.

Recent advances have moved or placed the microlens array such that the microlenses of the array focus on the image plane of the main lens from a position between the photosensor and the image plane of the main lens while maintaining the one focal length distance between the microlens array and the photosensor. This structural change may provide a trade-of between the spatial and angular resolutions, such that an increase of spatial resolutions may result in a decrease of angular resolutions, and vice versa. The microlenses are also focused on the image plane of the main lens instead of at infinity. This allows the microlenses of the microlens array to generate true images of the image seen by the main lens. Each of the microlenses then forms a real image on the sensor, just scaled in relation to the image formed by the main lens. Thus, the number of resolution of the image is no longer solely related to the number of microlenses, but rather the resolution of the images generated by the microlenses.

To improve on the embodiments of the plenoptic camera, a modulation transfer function (MTF) for the optical elements involved, specifically the MTF of the microlenses, should be improved. The MTF of an optical element corresponds to the optical element's ability to preserve brightness variations (or contrasts of an object or scene) when they pass through the optical element. In some embodiments, this may correlate to a spatial frequency of an object or scene viewed by the optical element. Specifically, the MTF can identify how well the optical element transfers objects of high frequency (for example, a number of small objects or sharp edges) in a scene being captured or viewed by the optical element. If the optical element has a poor (low) MTF, when the frequency of the objects is high, the images generated by the optical element do not have great definition of the small objects/sharp edges). When an optical element has a good (high) MTF and the frequency of the objects is high, the images generated by the optical element may have more definition of the small objects/sharp edges than the optical element with the poor MTF. In essence, the MTF of the optical element may correspond to the resolution and contrast of the resulting image.

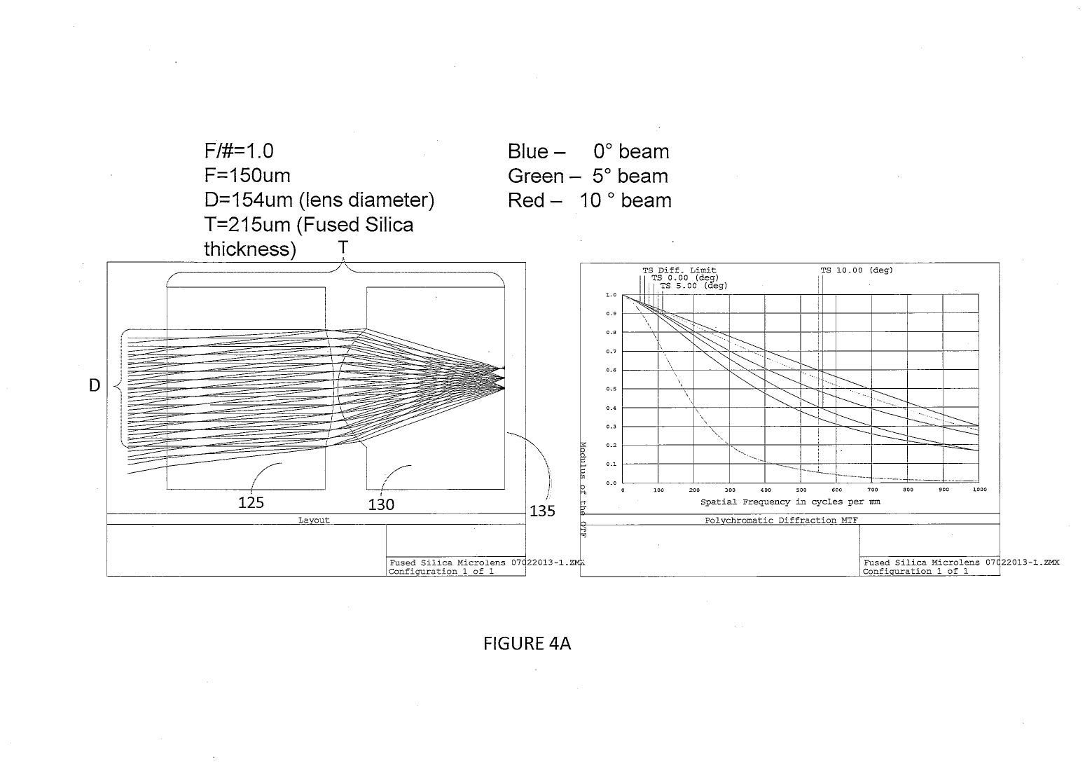

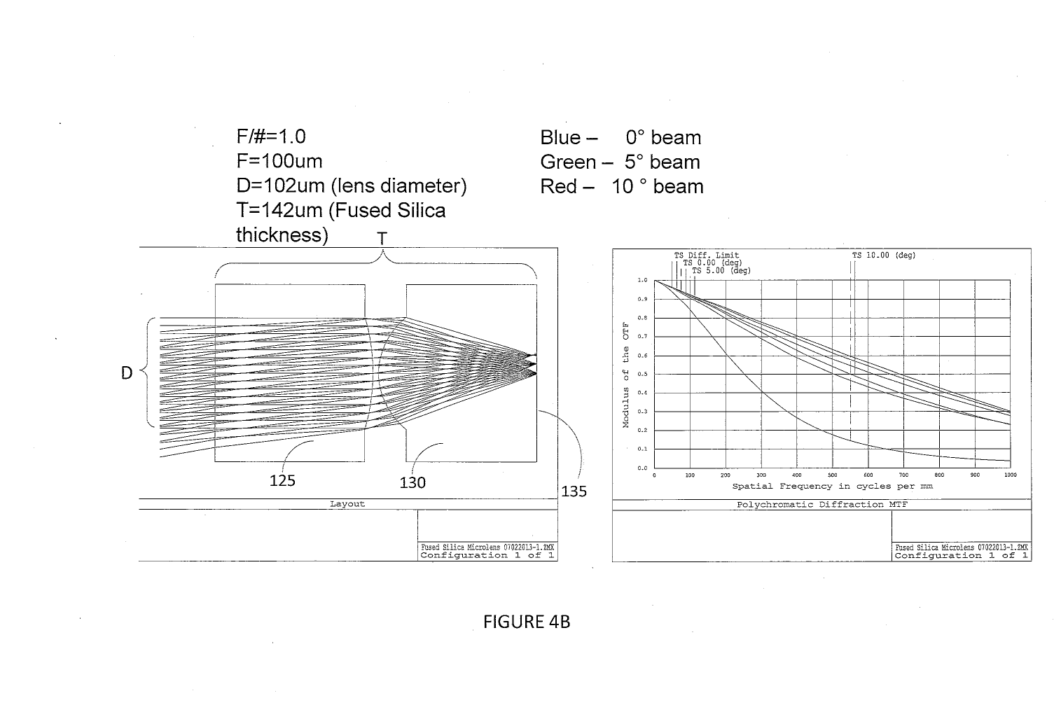

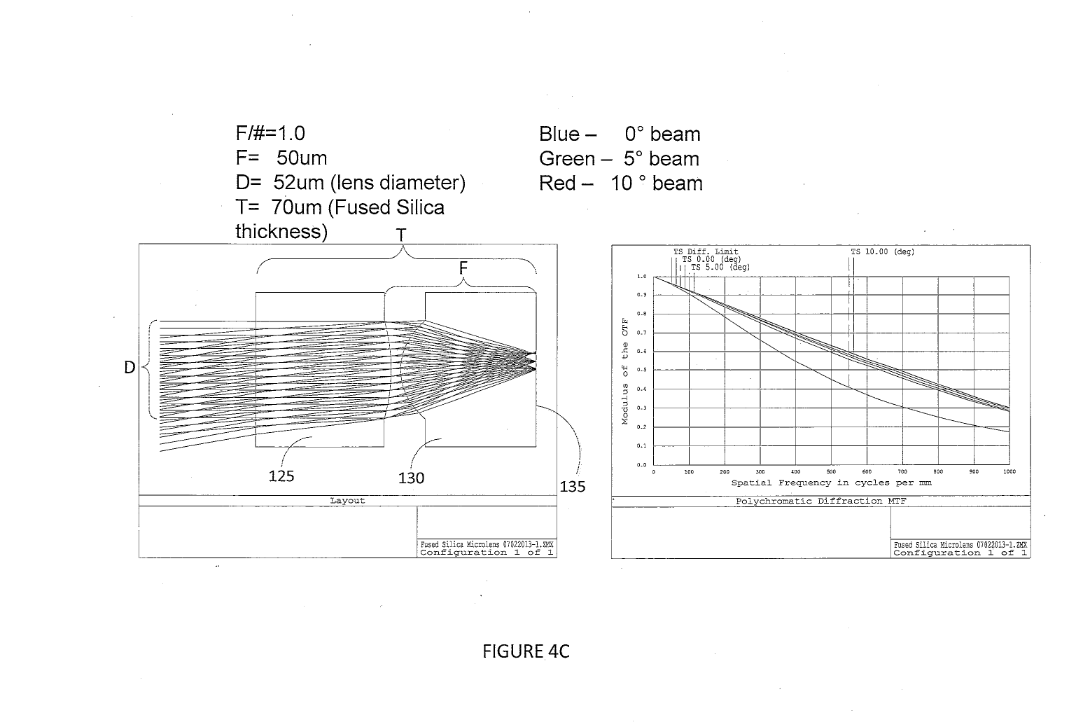

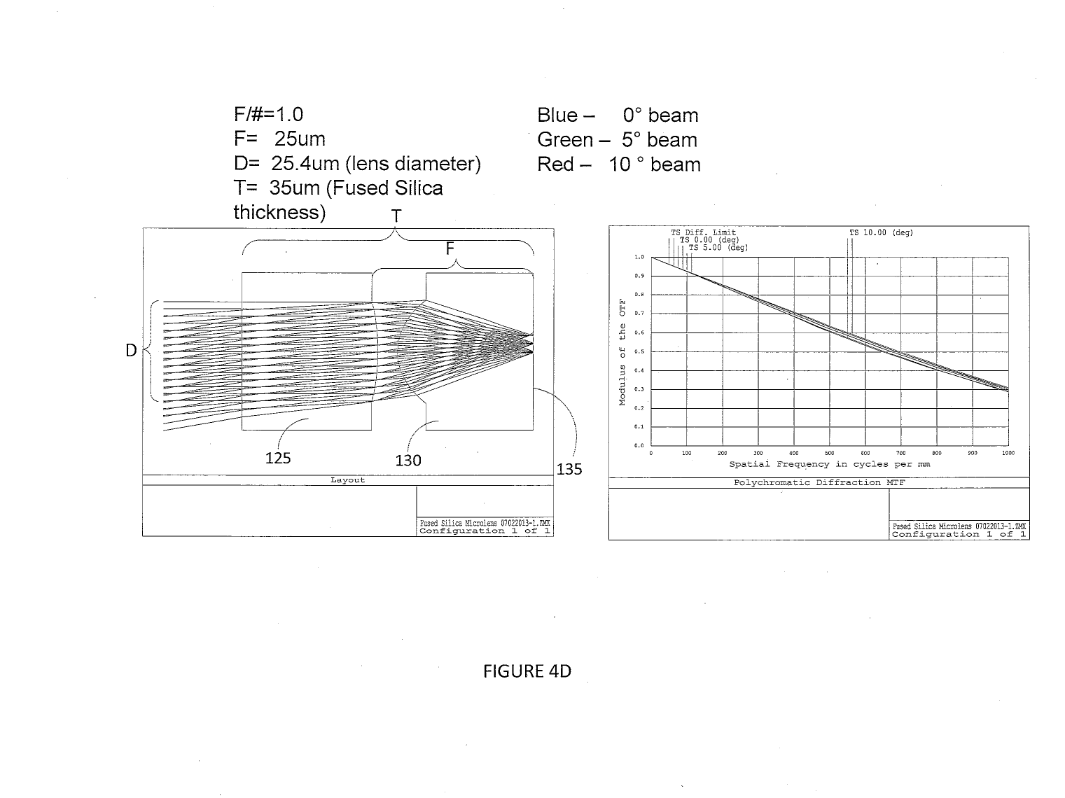

In identifying the MTF of an optical element or system, an MTF chart may be used. On the MTF chart (as shown in FIGS. 4A-4D), the y-axis may depict the MTF value as a percentage while the x-axis may depict increasing line pair frequency. Generally, as the line pair frequency increases along the x-axis, the MTF value of the optical element decreases. The MTF chart shows, for a given line pair frequency value, what percentage of line pairs are preserved when they pass through the optical element. Thus, a first optical element having a higher MTF at a given line pair frequency than a second optical element having a lower MTF at the same line pair frequency may be better (meaning may provide a sharper image) than the lower optical element, all other aspects being equal. For example, a cellphone camera optic system may have an MTF of approximately 20% at a line pair frequency of 350 lp/mm. As compared to other cameras, this MTF may be lower than average, and the cellphone camera may be described as poor camera. Above 350 lp/mm is above the Nyquist frequency, and currently many cameras do not need a response above the Nyquist frequency.

In some embodiments, plenoptic cameras use super-resolution to enhance the resolution of images generated by the optical elements of the camera. Super-resolution may involve increasing a resolution of a final image beyond the pixel resolution of the sensor. Super-resolution uses multiple images (for example, the multiple images of the microlenses of the microlens array 125 and the photosensor microlens array 130). Super-resolution may be limited by the MTF of the lenses (e.g., the microlenses of the microlens arrays) used in the plenoptic camera, because super-resolution uses the MTF that is above the Nyquist frequency, which is limited in most lenses. Specifically, single element lenses have limited MTF above the Nyquist frequency. Super-resolution may describe a set of methods or techniques for upscaling video or images. Super-resolution may be improved by using optical elements having high responses to high frequency objects in the scene being captured; accordingly, optical elements having high MTFs are desired. For example, the microlens array 125 and the photosensor microlens array 130 may form a 2-layer microlens array, which may be optically designed to increase the MTF of the microlens arrays beyond the Nyquist frequency, which improves the factor of super-resolution.

Accordingly, improving the MTF for the optical elements used in the plenoptic camera beyond a Nyquist frequency of the photosensor 135 may prove useful in applying super-resolution methods and techniques in generating images from the captured object or scene. For example, with the cellphone camera described above, the Nyquist frequency may be approximately 500 lp/mm. However, improving the MTF of the optical elements to be capable of preserving a majority of the line pairs at a frequency greater than the Nyquist frequency of the photosensor 135 may improve the super-resolution techniques and methods.

For example, with the cellphone camera described above in conjunction with methods and apparatus described herein, the Nyquist frequency of 500 lp/mm may be surpassed to 700 lp/mm or 1000 lp/mm. Such an increase in the frequency may mean that the frequency exceeds the pixels available on the photosensor, where a phase of the wavelength of the signal is shorter than the distance between two pixels of the photosensor. Higher frequencies beyond the Nyquist frequency benefits super-resolution. This is because higher frequencies mean that more information is available, which results in better resolution of the final images based on super-resolution. However, to reach higher frequencies beyond the Nyquist frequency, reaching such a frequency may need optics that are capable of good response at these high frequencies (for example, a high (above a given threshold) MTF at these frequencies). However, all lenses (following theories of diffraction limited optics) have a cutoff frequency. For example, lenses, even lenses with perfect optic properties, are limited to certain frequencies (for example, cutoff frequencies). The lenses may not respond to frequencies above the cutoff frequency, thus acting as filters at or above the cutoff frequency that pass only frequencies lower than the cutoff frequency.

In order to capture a frequency above the Nyquist frequency, there may be three requirements for the optical elements in question:

First, the optical element should have a low F-number, preferably equal to or close to f/1 (for example, f/1 or f/1.4). The optical elements used should be capable of through a high frequency of line pairs at low F-numbers (close to F/1) in order to obtain a high resolution image on the sensor.

Second, the F-number of the microlenses of the microlens array should match the objective lens. For example, using the plenoptic camera 100 of FIG. 1 as described above, the objective lens 110 focuses the image viewed by the plenoptic camera 100 at the main lens image plane 115 between the objective lens 110 and the microlens array 125 just in the air (not on any photosensor or other material/object/component), so the image is focused somewhere. This image is picked up from the air by the microlens array 125, and which maps it onto the photosensor 135. Hence, the plenoptic camera 100 may be a “two stage” system, the first stage comprising generating an image of the object or scene viewed by the objective lens 110 and the second stage comprising mapping the generated image from the main lens image plane 115 to the photosensor 135 via the microlens array 125. Each microlens of the microlens array 125 may act as a microcamera that takes a picture of a piece of the image at the main lens image plane and maps it to the photosensor 135. Since the microlenses of the microlens array 125 have to be at a low F-number (for example, f/1or f/1.4), the objective lens should also have a low f-number (for example, at f/1 or f/1.4). f/1 may be difficult to reach, but f/1.4 may be easier to obtain.

Third, a field of view of the microlenses of the microlens array 125 should be configured to correspond to the f-number of the objective lens 110. The f-number of an optical element is usually a number defining a ratio of the focal distance and the diameter of the aperture. When ignoring transmission efficiency of the optical element, the brightness of the image passed through the optical element relative to the brightness of the object or scene decreases with the square of the f-number. The microlenses of the microlens array 125 may be configured to see the entire aperture of the objective lens 110. The f-number is actually a ratio of the focal length to the diameter of an entrance pupil of the lens. The f-number is approximately a tangent of a half-angle of a maximum cone of light that can enter the lens. Alternatively, the f-number may be quantified as half an inverse numerical aperture (NA) of the lens. The NA=n* sin θ, where n is an index of refraction of a medium in which the lens operates and θ is a half-angle of a maximum cone of light that can enter the lens. The field of view of the microlenses of the microlens array 125 may be at least to the diameter of the objective lens 110. For example, when the objective lens has an f-number of f/1, then the field of view of the microlenses of the microlens array 125 may be configured to be 26-degrees on both sides of an optical axis of the microlenses of the microlens array 125. This can be computed using the tangent of the angle θ. At f/1.4, the microlenses of the microlens array 125 may be configured with a +/−20 degrees field of view such that they may see the entire image generated by the objective lens 110 (and the entire objective lens 110). Accordingly, each microlens of the microlens array 125 may view a slightly different part of a scene captured by the objective lens 110 because each microlens of the microlens array 125 may see through the objective lens 110 at a slightly different perspective.

When these three requirements are met, the image created by the objective lens 110 may be very sharp (for example, close to the diffraction limit), for example, at 700 lp/mm. Accordingly, the microlenses of the microlens array 125 may be configured to have an MTF such that they pass at least 20-30% of the image to the photosensor 135 at the 700 lp/mm; in other words, the microlenses of the microlens array 125 should be very sharp lenses.

Additionally, as dimensions of the microlenses of the microlens array 125 are made smaller (while maintaining the geometric relationships of the microlenses), the optic parameters of the microlenses improve (for example, meaning that the MTFs for each of the microlenses (frequency response) approaches the diffraction limit). FIGS. 4A-4D show the improvement in the MTFs for microlenses of various sizes having the same geometric relationships. As noted in each of the FIGS. 4A-4D, the f-number for each of the lenses used in the simulations is f/1.

When the dimensions of the microlenses of the microlens array 125 are described as being made smaller, this refers to the fact that the geometric relationships of the physical aspects of the lens (for example the relationships between the focal distance, the thickness, and the diameter of the microlenses stays the same), but the physical size of the microlenses gets smaller. For example, when a first microlens is half the size of a second microlens having the same geometric relationships, all the angles, relationships, etc., of the parameters of the first microlens are the same as those of the second microlens, but the physical size of the first microlens is smaller than that of the second microlens.

For example, as shown in FIGS. 4A-4D, each of the FIGS. 4A-4D depict an MTF chart and a schematic block diagram of embodiments of a microlens from the microlens array 125, a photosensor microlens from the photosensor microlens array 130, and a photosensor 135 in relation to signals passed through the respective microlenses and focused onto the photosensor 135. The schematic block diagrams describe the physical parameters of the microlenses (for example, the f-number, the diameter (D), the thickness (t), and the focal distance for the microlenses simulated in the specific figure).

As shown in these figures, if you keep the geometric relationships the same while adjusting the physical size of the microlenses, the MTFs consistently improve as the microlens becomes smaller. This improvement may be explained in part due to, as the lens gets smaller, a reduction of aberrations in the lenses (as related to aberration theory). Some aberrations of lenses may be due to the geometry of the optic elements, for example the size and shape. These aberrations may be called Seidel aberrations. For example, coma, which affects rays from points off the optical axis, is an aberration that may be improved as the diameter of the microlens of the microlens array 125 is reduced while the remaining aspects of the microlens remain the same.

FIGS. 4A-4D depict various schematic block diagrams and associated MTF charts for a plurality of embodiments of a two-surface microlens array for a low f-number plenoptic camera. Each schematic block diagram depicts the two-surface microlens array comprising two single-surface microlenses having convex microlenses that face each other, a photosensor, and examples of three signals passing through the microlens arrays and being focused on the photosensor. The three signals represent a first signal parallel to the optical axis, a second signal five degrees off the optical axis, and a third signal ten degrees off the optical axis. Each of the microlenses of the microlens arrays shown in the schematic block diagrams have an f-number of f/1. The microlenses of FIG. 4A have a focal distance (F) of 150 microns, a diameter of 154 microns, and a thickness of 215 microns. As described above, the diameter of the microlenses in FIGS. 4A-4D corresponds to the length of the curved portion of the microlenses along a length of the wafer of the microlens array (as shown in FIGS. 4A-4D). As shown in FIGS. 4A-4D, the thickness of the fused silica is measureable as being the distance from the photosensor 135 (FIG. 1) to the far edge of the microlens array 125 (FIG. 1). In FIGS. 4A-4D, the focal distance F is not physically measureable due to the complexities of the multi-lens system. The microlenses of FIG. 4B have a focal distance (F) of 100 microns, a diameter of 102 microns, and a thickness of 142 microns. The microlenses of FIG. 4C have a focal distance (F) of 50 microns, a diameter of 52 microns, and a thickness of 70 microns. The microlenses of FIG. 4D have a focal distance (F) of 25 microns, a diameter of 25.4 microns, and a thickness of 35 microns.

As shown in the FIGS. 4A-4D (and as verified by knowledge of Seidel aberrations noted above), the MTFs of optical elements approach their respective diffraction limits as the microlenses are scaled down in size while maintaining relationships of the optical elements. When viewing the FIGS. 4A-4D in progression, the MTF curve of each figure improves; the MTF of FIG. 4D is much improved over that of FIG. 4A, and each of FIGS. 4A-4D show improvements in the MTF one by one. As discussed above, the f-number is the same for each of the lenses and the focal length, the diameter, and the thicknesses are reduced from FIG. 4A-4D.

FIG. 4A, as noted above, depicts microlenses having focal distances of 150 microns, diameters of 154 microns, and thicknesses of 215 microns at f/1 and three signals in relation to the optical axis of the microlenses. The MTF chart of FIG. 4A depicts the typical MTF chart having the MTF of the respective microlenses as a percentage along the y-axis and frequency in lp/mm along the x-axis. The chart shows a diffraction limited MTF value, which is a line for an optic element that is only diffraction limited (a perfect optic element). Additionally, the chart shows two representations of the MTFs of the microlenses in relation to the three signals received (at the optical axis, five-degrees off the optical axis, and ten-degrees off the optical axis). Each of the three signals (and the diffraction limited representation) includes two separate lines, one for a sagittal MTF of the microlenses and the other for the meridional MTF. In the discussion below regarding the FIGS. 4A-4D, though not stated below, the discussion focuses on the MTF values of the various signals at 1000 lp/mm along the x-axis.

In FIG. 4A, since the diffraction limited lens is the “perfect lens,” the line representing the diffraction limited microlens has the highest values on the y-axis throughout the x-axis. Following the diffraction limited representation, the signal received at five-degrees off the optical axis (dashed) has the highest MTF for the microlenses of FIG. 4A and the solid MTF has the next highest MTF. The next highest MTF belongs to one MTF (solid) of the signal at ten-degrees off the optical axis (solid). Then, the MTF lines of the signal at the optical axis are shown (both dashed and solid), with the one MTF line of the signal at ten-degrees off the optical axis (dashed) having the lowest y-axis values throughout the chart. As shown, the diffraction limited optic element may be configured to have an MTF value of approximately 30% (0.3 on the y-axis) at 1000 lp/mm. The MTF lines for the three signals passed through the microlenses of FIG. 4A range from approximately 27% down to approximately 1%.

FIG. 4B, as noted above, depicts microlenses having focal distances of 100 microns, diameters of 102 microns, and thicknesses of 142 microns at f/1 and three signals in relation to the optical axis of the microlenses. Similar to that of FIG. 4A, the MTF chart of FIG. 4B depicts the typical MTF chart having the MTF of the respective microlenses as a percentage along the y-axis and frequency in lp/mm along the x-axis. The chart shows a diffraction limited MTF value, which is a line for an optic element that is only diffraction limited (a perfect optic element). Additionally, the chart shows two representations of the MTFs of the microlenses in relation to the three signals received (at the optical axis, five-degrees off the optical axis, and ten-degrees off the optical axis). Each of the three signals (and the diffraction limited representation) includes two separate lines, one for a sagittal MTF of the microlenses and the other for the meridional MTF.

In FIG. 4B, since the diffraction limited lens is the “perfect lens,” the line representing the diffraction limited microlens has the highest values on the y-axis throughout the x-axis. Following the diffraction limited representation, the signal received at five-degrees off the optical axis (dashed) has the highest MTF for the microlenses of FIG. 4A and the solid MTF has the next highest MTF. The next highest MTF belongs to one MTF (solid) of the signal at ten-degrees off the optical axis (solid). Then, the MTF lines of the signal at the optical axis are shown (both dashed and solid), with the one MTF line of the signal at ten-degrees off the optical axis (dashed) having the lowest y-axis values throughout the chart. As shown, the diffraction limited optic element may be configured to have an MTF value of approximately 30% (0.3 on the y-axis) at 1000 lp/mm. When compared to the MTF lines of FIG. 4A, the MTF lines for the three signals passed through the microlenses of FIG. 4B generally are much improved. The MTF lines of FIG. 4B range from approximately 29% down to approximately 5%. The MTF of the microlenses for signals at five-degrees off the optical axis improve from approximately 25 and 27% to 27 (solid) and 29% (dashed), while the MTF for signals at 10 degrees off the optical axis (solid) and parallel with the optical axis improve to approximately 23% from 17%. The dashed MTF for signals at ten-degrees off the optical axis improves to approximately 5%.

FIG. 4C, as noted above, depicts microlenses having focal distances of 50 microns, diameters of 52 microns, and thicknesses of 70 microns at f/1 and three signals in relation to the optical axis of the microlenses. Similar to that of FIGS. 4A and 4B, the MTF chart of FIG. 4C depicts the typical MTF chart having the MTF of the respective microlenses as a percentage along the y-axis and frequency in lp/mm along the x-axis. The chart shows a diffraction limited MTF value, which is a line for an optic element that is only diffraction limited (a perfect optic element). Additionally, the chart shows two representations of the MTFs of the microlenses in relation to the three signals received (at the optical axis, five-degrees off the optical axis, and ten-degrees off the optical axis). Each of the three signals (and the diffraction limited representation) includes two separate lines, one for a sagittal MTF of the microlenses and the other for the meridional MTF.

In FIG. 4C, the MTF of the diffraction limited lens is actually shown as being slightly lower than the dashed MTF of the microlenses for a signal at five-degrees off the optical axis, both at approximately 30%, which may be a result of simulation software using only ray optics and not physical wave optics. Next, the signal received at five-degrees off the optical axis (solid) has the highest MTF for the microlenses of FIG. 4C. The next highest MTF belongs to one MTF (solid) of the signal at ten-degrees off the optical axis (solid). Then, the MTF lines of the signal at the optical axis are shown (both dashed and solid), with the one MTF line of the signal at ten-degrees off the optical axis (dashed) having the lowest y-axis values throughout the chart. When compared to the MTF lines of FIGS. 4A and 4B, the MTF lines for the three signals passed through the microlenses of FIG. 4C generally are improved. The MTF lines of FIG. 4C range from approximately 30% down to approximately 17%. The MTF of the microlenses for signals at five-degrees off the optical axis improve to approximately 30% (both solid and dashed), while the MTF for signals at 10 degrees off the optical axis (solid) and parallel with the optical axis improve to approximately 28%. The dashed MTF for signals at ten-degrees off the optical axis improves to approximately 17%.

Finally, FIG. 4D, as noted above, depicts microlenses having focal distances of 25 microns, diameters of 25.4 microns, and thicknesses of 35 microns at f/1 and three signals in relation to the optical axis of the microlenses. Similar to that of FIGS. 4A-4C, the MTF chart of FIG. 4D depicts the typical MTF chart having the MTF of the respective microlenses as a percentage along the y-axis and frequency in lp/mm along the x-axis. The chart shows a diffraction limited MTF value, which is a line for an optic element that is only diffraction limited (a perfect optic element). Additionally, the chart shows two representations of the MTFs of the microlenses in relation to the three signals received (at the optical axis, five-degrees off the optical axis, and ten-degrees off the optical axis). Each of the three signals (and the diffraction limited representation) includes two separate lines, one for a sagittal MTF of the microlenses and the other for the meridional MTF.

As shown in FIG. 4D, the MTF of the diffraction limited lens is actually shown as being slightly lower than the MTFs of the microlenses for the signals at five-degrees and ten-degrees off the optical axis, both at approximately 30%. Next, the signal received at five-degrees off the optical axis has the highest MTF for the microlenses of FIG. 4D. The next highest MTF belongs to one MTF of the signal at ten-degrees off the optical axis (solid), also at approximately 30%. Then, the MTF lines of the signal at the optical axis are shown (both dashed and solid), with the MTF at approximately 29%.

Once the necessary dimensions for the microlenses are known (based on FIG. 4D, the microlenses for both the microlens array 125 and the photosensor microlens array 130 should have a focal length of 25 microns, a diameter of 25.4 microns, and a thickness of 35 microns, the microlenses must be manufactured. However, known processes for manufacturing microlenses may not be easily applied to microlenses of this size. Known manufacturing processes for microlenses may be best utilized for microlenses of approximately half a millimeter in diameter. However, as the size of the microlenses gets smaller lenses, manufacturing those lenses increases in difficulty. Various issues may arise in the production of microlenses as they become smaller. For example, alignment of the microlenses (with each other or with the photosensor 135) becomes more difficult as the microlenses become smaller.

When manufactured, microlenses (made of glass) may be formed onto wafers. These wafers may be made of glass (or any other material used in optics), and the glass wafers are often thicker than the microlenses formed thereon. For example, for a microlens having a thickness of 150 microns, the glass wafer may be 500 microns thick. Wafer development processes used in the manufacture of optics may be similar to the processes used in the semiconductor industry, but using silicon dioxide (glass) instead of silicon. In some embodiments, the microlenses may be formed from epoxy that is deposited on the glass wafer. When using this process for wafer level optics, similar issues that arise in the semiconductor industry may arise in the wafer-level optics.

Microlenses may be manufactured as a single surface. Unlike the objective lens 110 of a camera which may contain multiple optic elements and/or multiple lens surfaces, the microlenses of the microlens array 125 and the photosensor microlens array 130 may each comprise a single curved surface. The other surface (opposite the curved surface) of the microlens may be flat. As illustrated in an example implementation of FIG. 3, the curved surface of the microlens array 125 and the curved surface of the microlens array 125 may be disposed to face each other. Accordingly, a flat surface of the microlens array 125 may face the objective lens 110, and a flat surface of the photosensor microlens array 130 may face and be disposed adjacent to the photosensor 130. The photosensor microlens array 130 and the microlens array 125 may each include a flat surface and a curved surface because it may be difficult to align two curved surfaces at such small sizes.

Additionally, or alternatively, the glass wafer on which the microlens is formed may have a thickness of 1 mm or 0.5 mm. At less than 0.5 mm, the glass wafer may become brittle and difficult to handle. Accordingly, a two surface microlens may be exceedingly difficult to manufacture on a single wafer because the microlenses on opposite sides of the wafer may be difficult to align and the thickness of the glass wafer may cause the microlenses to be too far apart. Given the short focal length of the microlenses (as short as 25 microns, the distance between the microlenses of the microlens array 125 should be less than the focal length. Thus, if the two microlenses were to be formed on the same glass wafer, the wafer would need to be between 20-50 microns in thickness, and such thin wafers are not easily manufactured.

Since the glass wafer is so thick, the microlens structure (glass wafer and microlens) must be placed such that the microlenses face the photosensor. If the microlenses are facing away from the photosensor, then the light (after passing through the microlenses themselves) must then pass through 500 microns of glass (or whatever the thickness of the glass wafer), at least, and this thickness of glass is much greater than the focal length of the microlenses, so there will be no image for the photosensor to capture. However, if the microlenses are turned to face the photosensor (such that glass portion is facing away from sensor), then there is no second surface for the light to pass through, and the single surface will be close to the photosensor and the photosensor will be able to capture the image in focus from the microlenses of the microlens array.

Current embodiments of plenoptic cameras may manufacture microlenses by molding epoxy on glass wafers. For example, one side of the glass wafer may be covered with epoxy. The microlenses of the microlens array may then be molded onto the epoxy. Epoxy may be a suitable material to deposit on the photosensor because it has a lower melting point than glass (glass is too hot and may destroy the photosensor). In some embodiments, epoxy may be spun onto the photosensor, and a master mold may be used to replicate the microlenses in the epoxy. In some embodiments, a wafer of epoxy microlenses may then be placed in close proximity to the sensor (20-30 microns) so that the microlenses of the microlens array may properly focus the image at the main lens image plane onto the photosensor. The 20-30 microns may be the only distance in which the location of the microlens array may be manipulated from the sensor due to the focal length of the microlenses of the microlens array. Microlenses as used in the microlens array may be problematic due to the small field of view FOV these lenses often have. For example, in FIGS. 4A-4D, the signals that are ten-degree off the optical axis have the worst MTF, the signals that are five-degrees off the optical axis have better MTF than those that are ten-degrees off, and signals that are parallel with the optical axis have the best MTF. This may be due to the fact that when the signal is further away from the optical axis, the lens is no longer symmetrical for that signal. Since these embodiments only comprise the single lens, there is no way to correct for the imperfections, and aberrations are generated, which may result in a low MTF.

Accordingly, the second lens surface as described above and shown in the FIGS. 1-4D allow us to increase the FOV of the microlenses by using two surfaces that are formed on two separate wafers, where the microlenses formed on each of the separate wafers are positioned such that the microlenses of each wafer face each other (As shown in FIGS. 4A-4D. A distance between the two microlenses may be very small (for example less than 20 microns. As discussed above, the wafer on which the microlenses nearest the photosensor may be limited in allowed thickness (and other practical issues). Accordingly, the photosensor may be covered with epoxy, and the microlenses may be replicated directly on the epoxy that directly covers the photosensor. For example, in the schematic block diagrams of FIGS. 4A-4D, the lenses on the right are formed of epoxy and replicated on the photosensor. The other wafer (the microlenses on the left) may still be the 0.5 mm thick glass wafer, which may be aligned with the epoxy microlens wafer and sensor.

Thus, there may be two versions of a plenoptic camera having two lens surfaces:

First, the two microlens arrays may each use glass wafers, where the second glass wafer (for the microlens array nearest the photosensor) is as thin as possible. This version may be limited by how fragile glass is at very low thicknesses.

Second, the first microlens array (furthest from the photosensor) may be replicated onto the epoxy layer which covers the photosensor directly and the single glass wafer for the other microlens array may be normal thickness.

From the schematic block diagrams of FIGS. 4A-4D and as described above, the microlenses shown and described have plus or minus a ten-degree FOV, and that's not sufficient. It needs to be closer to +/−20-50, as described above, in order to match the FOV of the microlenses of the microlens arrays 125/130 to the f/number of the objective lens 110. If both the objective lens 110 and the microlenses of the microlens array 125/130 are both at f/1, then the FOV of the microlenses of the microlens arrays 125/130 may be +/−26 degrees, which is not possible with only two lens surfaces as described herein. With just two surfaces, we can correct up to +/−10 degrees off the optical axis. However, if the f/number can be increased to f/1.4, then the two lens surfaces as described above may reduce the aberrations of the ML are less because the aperture is smaller so the ML can handle close to diffraction limited +/−20 degrees (not 26, but close) and then at F/1.4, the MCL also has an angle of 20-degrees, so everything works. At about F/1.4, what we are describing here is somewhat possible and we can get amazing, ultra-sharp ML at 700 lp/mm at small sizes that can be manufactured.

The approach described herein places the microlenses of the photosensor microlens array 130 in direct contact with the sensor. In the example implementations described above, the microlenses may be small (for example, approximately 20-50 microns in diameter). As discussed above, the microlenses are observed become sharper as their size becomes smaller. Accordingly, images passed through the microlenses become very crisp and the MTF of the microlenses increases. The optical quality of the microlenses improves, especially when the microlenses comprise multiple lens surfaces (2 or more), including for example, implementations described herein where the total number of curved surfaces microlens array 125 and the photosensor microlens array 130 is two. That is, a ray of light passes through two curved surfaces as it propagates from the image plane of an objective lens (for example, image plane 120 FIG. 1) to a sensor (for example, sensor 135 FIG. 1). The MTF is sufficiently improved such that the f-number of the microlenses and the plenoptic camera can be reduced to almost f/1. F/1 is very low and is often not used in photography because it is expensive to develop optic elements capable of operating at f/1.

Optic elements having an f-number of f/1 are desired because they can pass very sharp images. When the image is very sharp, super resolution techniques may be applied to the image. Describing the picture as very sharp may mean that the pixels of the image of a size close to 1 micron pixel size (such as 1.4 microns or 1.1 microns pixel sizes) are bigger than the diffraction limited spot that the lens makes. The size of this diffraction limited spot made by the lens depends on the quality of the lens and the f-number. At low f-numbers (for example, at or around f/1), the pixels can be larger than the diffraction limited spot. Furthermore, the pixel size may be larger than the diffraction limited spot only when the microlenses are small and when the microlenses are at least two elements. However, as discussed above, a single surface lens is insufficient to reduce f-number to approximately 1. So a second lens surface is introduced by depositing a second layer of microlenses directly on the surface of the sensor itself while the first layer is on the thicker glass wafer where the microlenses face the sensor (and thus the second array of microlenses).

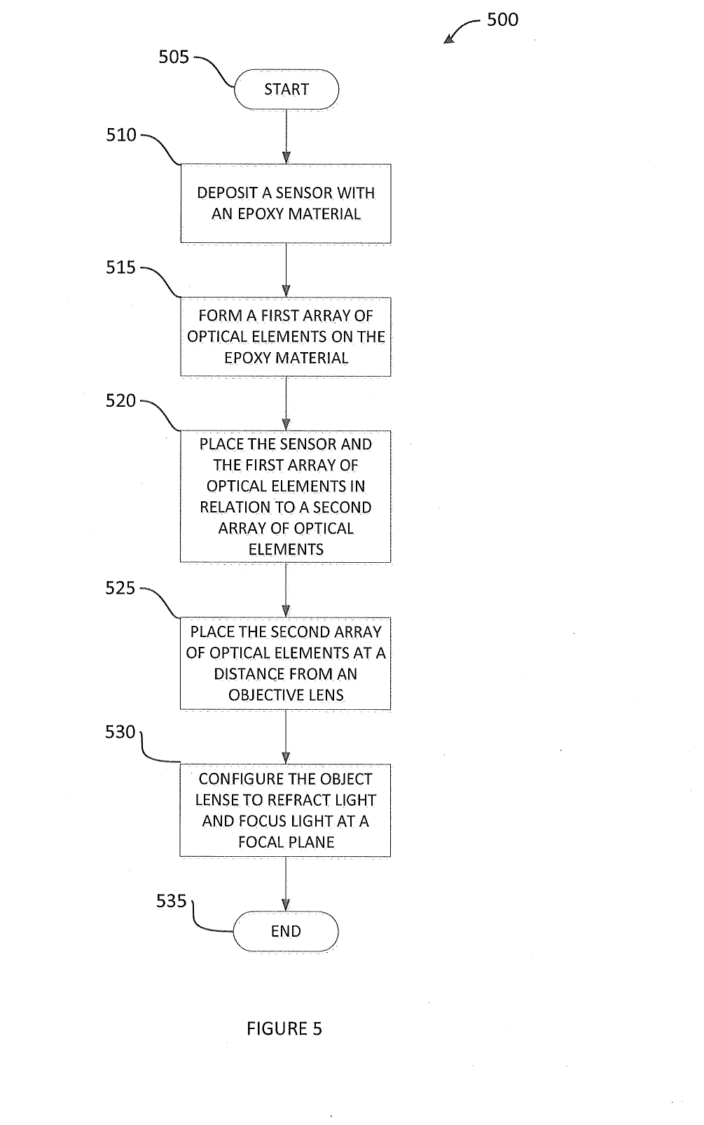

FIG. 5 illustrates a flow chart of an example of a method for manufacturing a two-surface microlens array for a low F-number plenoptic camera. The method 500 begins at block 505 and proceeds to block 510. At block 510, the method 500 deposits (or otherwise forms) a sensor with an epoxy material. For example, the method 500 deposits the sensor 135 (FIG. 1). The sensor may comprise a plurality of pixels configured to process light. The sensor may include an epoxy material which may serve as a support structure. Once the sensor is deposited, the method 500 proceeds to block 515.

At block 515, the method 500 forms a first array of optical elements on the epoxy material. In some embodiments, the first array of optical elements may correspond to the sensor microlens array 130 (FIG. 1). Each optical element of the first array of optical elements may direct light to one or more pixels of the sensor. Once the first array of optical elements is formed, the method 500 proceeds to block 520.

At block 520, the method 500 places the sensor and the first array of optical elements in relation to a second array of optical elements. The second array of optical elements may correspond to the microlens array 125 (FIG. 1). In some embodiments, the sensor and the first array of optical elements may be placed at a distance less than or equal to a focal distance of one or more optical elements of the first array of optical elements from the second array of optical elements. The focal distance may correspond to a distance matching the focal length of the one or more optical elements. The second array of optical elements may comprise a plurality of optical elements. Once the method 500 places the sensor and the first array of optical elements a distance from the second array of optical elements, the method 500 proceeds to block 525.

At block 525, the method 500 places the second array of optical elements at a distance from an objective lens. The objective lens may correspond to the objective lens 110 (FIG. 1). The second array of optical elements may be placed in relation to the objective lens such that optical elements of the second array of optical elements focus on an image plane of the objective lens. This allows the second array of optical elements to view portions of the field of view of the objective lens from different perspectives. Once the method 500 places the second array of optical elements in relation to the objective lens, the method 500 proceeds to block 530.

At block 535, the method 500 configures the objective lens to refract light received from a scene and to focus light propagating through the objective lens at a focal plane.at block 530. Once the method 500 configures the objective lens, the method 500 ends at block 535.

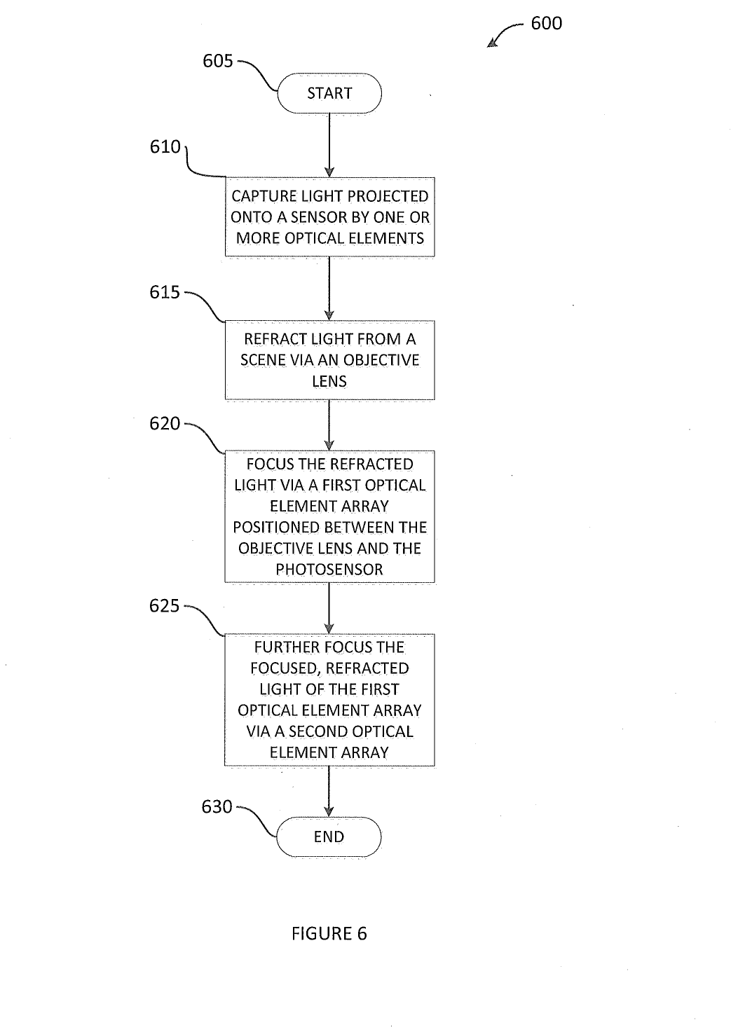

FIG. 6 illustrates a flow chart of an example of a method of capturing an image using a two-surface microlens array of a low F-number plenoptic camera. The method 600 begins at block 605 and proceeds to block 610. At block 610, the method 600 captures light projected onto a sensor by one or more optical elements. The sensor may correspond to the sensor 135 (FIG. 1). The sensor may comprise a plurality of pixels configured to process light. The sensor may include an epoxy material which may serve as a support structure. Once the method 600 captures light projected onto the sensor, the method 600 proceeds to block 615.

At block 615, the method 600 refracts light from a scene via an objective lens. The objective lens may correspond to the objective lens 110 (FIG. 1). The objective lens may focus light propagating through the objective lens at a focal point. The image plane may correspond to the mains lens image plane 120. Once the method 600 refracts light from the scene via the objective lens, the method proceeds to block 620.

At block 620, the method 600 focuses the refracted light via a first optical element array positioned between the objective lens and the sensor. The first optical element array may correspond to the microlens array 125 (FIG. 1). In some embodiments, the first optical element array comprises a first plurality of optical elements. Once the method 600 focuses the refracted light via the first optical element array, the method 600 proceeds to block 625.

At block 625, the method 600 further focuses the focused, refracted light of the first optical element array by a second optical element array. The second optical array may correspond to the sensor microlens array 130 (FIG. 1). The second optical array may be positioned between the first optical element array and the sensor. In some embodiments, the second optical element array comprises a second plurality of optical elements. The second optical element array is positioned to be in contact with the sensor. Each optical element of the second array of optical elements may direct light to one or more pixels of the sensor. Once the method 600 corrects imperfections of the focused, refracted light, the method 600 ends at block 630. In some embodiments, the method 600 projects a separate portion of the image of the scene formed at the focal plane of the objective lens onto a separate optical element of the second optical element array via each optical element of the first optical element array. In some embodiments, the method 600 further projects the separate portion of the image of the scene onto a separate location of the sensor via each optical element of the second optical element array.

### Implementing Systems and Terminology

Implementations disclosed herein provide systems, methods and apparatus for capturing imaging having high modulation transfer functions (MTF) with improved optical quality and reduced f-number (or focal ratio, f-stop, relative aperture, etc.). One skilled in the art will recognize that these embodiments may be implemented in hardware, software, firmware, or any combination thereof.

In some embodiments, the circuits, processes, and systems discussed above may be utilized in a wireless communication device. The wireless communication device may be a kind of electronic device used to wirelessly communicate with other electronic devices. Examples of wireless communication devices include cellular telephones, smart phones, Personal Digital Assistants (PDAs), e-readers, gaming systems, music players, netbooks, wireless modems, laptop computers, tablet devices, etc.

The wireless communication device may include one or more image sensors, two or more image signal processors, a memory including instructions or modules for carrying out the CNR process discussed above. The device may also have data, a processor loading instructions and/or data from memory, one or more communication interfaces, one or more input devices, one or more output devices for example a display device and a power source/interface. The wireless communication device may additionally include a transmitter and a receiver. The transmitter and receiver may be jointly referred to as a transceiver. The transceiver may be coupled to one or more antennas for transmitting and/or receiving wireless signals.

The wireless communication device may wirelessly connect to another electronic device (e.g., base station). A wireless communication device may alternatively be referred to as a mobile device, a mobile station, a subscriber station, a user equipment (UE), a remote station, an access terminal, a mobile terminal, a terminal, a user terminal, a subscriber unit, etc. Examples of wireless communication devices include laptop or desktop computers, cellular phones, smart phones, wireless modems, e-readers, tablet devices, gaming systems, etc. Wireless communication devices may operate in accordance with one or more industry standards for example the 3rd Generation Partnership Project (3GPP). Thus, the general term “wireless communication device” may include wireless communication devices described with varying nomenclatures according to industry standards (e.g., access terminal, user equipment (UE), remote terminal, etc.).

The functions described herein may be stored as one or more instructions on a processor-readable or computer-readable medium. The term “computer-readable medium” refers to any available medium that can be accessed by a computer or processor. By way of example, and not limitation, such a medium may comprise RAM, ROM, EEPROM, flash memory, CD-ROM or other optical disk storage, magnetic disk storage or other magnetic storage devices, or any other medium that can be used to store desired program code in the form of instructions or data structures and that can be accessed by a computer. Disk and disc, as used herein, includes compact disc (CD), laser disc, optical disc, digital versatile disc (DVD), floppy disk and Blu-ray® disc where disks usually reproduce data magnetically, while discs reproduce data optically with lasers. It should be noted that a computer-readable medium may be tangible and non-transitory. The term “computer-program product” refers to a computing device or processor in combination with code or instructions (e.g., a “program”) that may be executed, processed or computed by the computing device or processor. As used herein, the term “code” may refer to software, instructions, code or data that is/are executable by a computing device or processor.

The methods disclosed herein comprise one or more steps or actions for achieving the described method. The method steps and/or actions may be interchanged with one another without departing from the scope of the claims. In other words, unless a specific order of steps or actions is required for proper operation of the method that is being described, the order and/or use of specific steps and/or actions may be modified without departing from the scope of the claims.

It should be noted that the terms “couple,” “coupling,” “coupled” or other variations of the word couple as used herein may indicate either an indirect connection or a direct connection. For example, if a first component is “coupled” to a second component, the first component may be either indirectly connected to the second component or directly connected to the second component. As used herein, the term “plurality” denotes two or more. For example, a plurality of components indicates two or more components.

The term “determining” encompasses a wide variety of actions and, therefore, “determining” can include calculating, computing, processing, deriving, investigating, looking up (e.g., looking up in a table, a database or another data structure), ascertaining and the like. Also, “determining” can include receiving (e.g., receiving information), accessing (e.g., accessing data in a memory) and the like. Also, “determining” can include resolving, selecting, choosing, establishing and the like.

The phrase “based on” does not mean “based only on,” unless expressly specified otherwise. In other words, the phrase “based on” describes both “based only on” and “based at least on.”

In the foregoing description, specific details are given to provide a thorough understanding of the examples. However, it will be understood by one of ordinary skill in the art that the examples may be practiced without these specific details. For example, electrical components/devices may be shown in block diagrams in order not to obscure the examples in unnecessary detail. In other instances, such components, other structures and techniques may be shown in detail to further explain the examples.

Headings are included herein for reference and to aid in locating various sections. These headings are not intended to limit the scope of the concepts described with respect thereto. Such concepts may have applicability throughout the entire specification.

It is also noted that the examples may be described as a process, which is depicted as a flowchart, a flow diagram, a finite state diagram, a structure diagram, or a block diagram. Although a flowchart may describe the operations as a sequential process, many of the operations can be performed in parallel, or concurrently, and the process can be repeated. In addition, the order of the operations may be re-arranged. A process is terminated when its operations are completed. A process may correspond to a method, a function, a procedure, a subroutine, a subprogram, etc. When a process corresponds to a software function, its termination corresponds to a return of the function to the calling function or the main function.

The previous description of the disclosed implementations is provided to enable any person skilled in the art to make or use the present invention. Various modifications to these implementations will be readily apparent to those skilled in the art, and the generic principles defined herein may be applied to other implementations without departing from the spirit or scope of the invention. Thus, the present invention is not intended to be limited to the implementations shown herein but is to be accorded the widest scope consistent with the principles and novel features disclosed herein.

Terms and phrases used in this application, and variations thereof, especially in the appended claims, unless otherwise expressly stated, should be construed as open ended as opposed to limiting. As examples of the foregoing, the term ‘including’ should be read to mean ‘including, without limitation,’ ‘including but not limited to,’ or the like; the term ‘comprising’ as used herein is synonymous with ‘including,’ ‘containing,’ or ‘characterized by,’ and is inclusive or open-ended and does not exclude additional, unrequited elements or method steps; the term ‘having’ should be interpreted as ‘having at least;’ the term ‘includes’ should be interpreted as ‘includes but is not limited to;’ the term ‘example’ is used to provide exemplary instances of the item in discussion, not an exhaustive or limiting list thereof; and use of terms like ‘preferably,’ ‘preferred,’ ‘desired,’ or ‘desirable,’ and words of similar meaning should not be understood as implying that certain features are critical, essential, or even important to the structure or function, but instead as merely intended to highlight alternative or additional features that may or may not be utilized in a particular embodiment. In addition, the term “comprising” is to be interpreted synonymously with the phrases “having at least” or “including at least”. When used in the context of a process, the term “comprising” means that the process includes at least the recited steps, but may include additional steps. When used in the context of a compound, composition or device, the term “comprising” means that the compound, composition or device includes at least the recited features or components, but may also include additional features or components. Likewise, a group of items linked with the conjunction ‘and’ should not be read as requiring that each and every one of those items be present in the grouping, but rather should be read as ‘and/or’ unless expressly stated otherwise. Similarly, a group of items linked with the conjunction ‘or’ should not be read as requiring mutual exclusivity among that group, but rather should be read as ‘and/of’ unless expressly stated otherwise.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity. The indefinite article “a” or “an” does not exclude a plurality. A single processor or other unit may fulfill the functions of several items recited in the claims. The mere fact that certain measures are recited in mutually different dependent claims does not indicate that a combination of these measures cannot be used to advantage. Any reference signs in the claims should not be construed as limiting the scope.

What is claimed is:

1. A system for generating plenoptic images, the system comprising:
an objective lens configured to refract light received from a scene, the objective lens configured to focus light at an image plane;
a sensor configured to sense light received thereon, the sensor positioned to receive light propagating through the objective lens;
a first optical element array positioned between the objective lens and the sensor, the first optical element array comprising a first plurality of optical elements; and
a second optical element array positioned between the first optical element array and the sensor and in contact with the sensor, the second optical element array comprising a second plurality of optical elements,
wherein each optical element of the first optical element array is configured to direct light rays passing through the image plane of the objective lens onto a separate optical element of the second optical element array and wherein each optical element of the second optical element array is configured to direct light rays received from the first optical element array onto a separate location of the sensor.

2. The system of claim 1, wherein the first plurality of optical elements have a first focal length on a first side of the first optical element array, and wherein the first optical element array is positioned at a distance from the image plane of the objective lens equal to the first focal length and further positioned such that the first side of the first optical element array receives light from the objective lens.

3. The system of claim 2, wherein the first plurality of optical elements have a second focal length on a second side of the first optical element array, and wherein the first optical element array is positioned such that the second side of the first optical element array faces the sensor.

4. The system of claim 1,
wherein the first optical element array has a first side that faces the objective lens and a second side that faces the second optical element array;
wherein the first side of the first optical element array is planar; and
wherein each of the first plurality of optical elements have a curved surface and the curved surfaces of each of the first plurality of optical elements are disposed on the second side of the first optical array.

5. The system of claim 1,
wherein the second optical element array has a first side that faces the first optical element array and a second side that faces the sensor;
wherein each of the second plurality of optical elements have a curved surface and the curved surfaces of each of the second plurality of optical elements are disposed on the first side of the second optical element array.

6. The system of claim 5, wherein the second side of the second optical element array is planar.

7. The system of claim 1, wherein each optical element of the first optical element array is aligned with a corresponding optical element of the second optical element array.

8. The system of claim 1, wherein the second optical element array is integrated with the sensor as a single component, the second optical element arranged on a side of the sensor configured to receive light.

9. The system of claim 1, wherein the second optical element array comprises epoxy.

10. The system of claim 1, wherein the first optical element array is spaced a distance from the sensor equal to a diameter of an optical element of the first optical element array.

11. The system of claim 6, wherein the diameter of an optical element of the first optical element array is 20-30 microns.

12. The system of claim 1, wherein the first optical element array comprises a glass layer, and wherein the glass layer has a thickness of at least five times the thickness of one of the first plurality of optical elements.

13. The system of claim 1, wherein the second optical element array comprises a glass layer, and wherein the glass layer has a thickness of at least five times the thickness of one of the second plurality of optical elements.

14. A method for generating plenoptic images, the method comprising:
capturing light projected onto a sensor by one or more optical elements;
refracting light from a scene via an objective lens, the objective lens configured to focus light propagating through the objective lens at an image plane;
focusing the refracted light via a first optical element array positioned between the objective lens and the sensor, the first optical element array comprising a first plurality of optical elements; and
further focusing light received from the first optical element array by a second optical element array positioned between the first optical element array and a sensor, the second optical element array positioned in contact with the sensor, the second optical element array comprising a second plurality of optical elements,
wherein each optical element of the first optical element array is configured to project a separate portion of the image of the scene formed at the image plane onto a separate optical element of the second optical element array, and wherein each optical element of the second optical element array is configured to project the separate portion of the image of the scene onto a separate location of the sensor.

15. The method of claim 14, wherein the first plurality of optical elements have a first focal length, and the first optical element array is positioned at a distance from the image plane of the objective lens equal to the first focal length.

16. The method of claim 14, wherein each optical element of the first optical element array is aligned with a corresponding optical element of the second optical element array, and wherein light propagating through one of the optical elements of the first optical element array is received by the corresponding optical element of the second optical element.

17. The method of claim 14, wherein the second optical element array is integrated with the sensor as a single component, the second optical element array arranged on a side of the sensor configured to receive light.

18. The method of claim 17, wherein the second optical element array comprises epoxy.

19. The method of claim 14, wherein the first optical element array is spaced a distance from the sensor equal to a diameter of an optical element of the first optical element array.

20. The method of claim 19, wherein the diameter of an optical element of the first optical element array is 20-30 microns.

21. A method of manufacturing one or more optic elements for a plenoptic imaging system, comprising:
depositing epoxy on a sensor configured to sense light received thereon;
providing a first array of optical elements for the plenoptic imaging system, the first array of optical elements having first plurality of optical elements;
forming a second array of optical elements comprising the epoxy, the second array of optical elements having a second plurality of optical elements, each of the second plurality of optical elements configured to direct light to one or more pixels of the sensor;
positioning the sensor and the second array of optical elements at a location to receive light from the first array of optical elements and at a distance from the first array of optical elements that is less than the distance of a focal length of one of the first plurality of optical elements; and
positioning the first array of optical elements between the sensor and an objective lens, the objective lens configured to focus light at an image plane between the first array of optical elements and the objective lens, the first array of optical elements being positioned at a distance from the image plane that is equal to the focal length of one of the first plurality of optical elements.

22. The method of claim 21,
wherein the first array of optical elements has a first side that faces the objective lens and a second side that faces the second array of optical elements;
wherein the first side of the first array of optical elements is planar; and
wherein each of the first plurality of optical elements have a curved surface and the curved surfaces of each of the first plurality of optical elements are disposed on the second side of the first optical array.

23. The method of claim 21,
wherein the second array of optical elements has a first side that faces the first optical array and a second side that faces the sensor;
wherein each of the second plurality of optical elements have a curved surface and the curved surfaces of each of the second plurality of optical elements are disposed on the first side of the second array of optical elements.

24. The method of claim 23, wherein the second side of the second array of optical elements is planar.

25. The system of claim 24, further comprising aligning each the second plurality of optical elements and a corresponding one of the first plurality of optical elements so that light propagating through one of the first plurality of optical elements is received by the corresponding one of the second plurality of optical elements.

26. The method of claim 21, further comprising forming the second array of optical elements array by replication from a master array of optical elements.

27. The method of claim 21, wherein the first array of optical elements is spaced a distance from the sensor equal to a diameter of an optical element of the first array of optical elements.

28. The method of claim 21, wherein the diameter of one of the first plurality of optical elements is 20-30 microns.

29. The method of claim 21, wherein the first array of optical elements are formed on a glass layer having a thickness at least five times the thickness of the one of the first plurality of optical elements

30. The method of claim 21, wherein the second array of optical elements are formed on a layer of epoxy having a thickness at least five times the thickness of one of the second plurality of optical elements.
